(19) United States
(12) Patent Application Publication
(10) Pub. No.: US 2006/0170669 A1
(43) Pub. Date: Aug. 3, 2006

(54) Digital picture frame and method for editing

(76) Inventors: Jay S. Walker, Ridgefield, CT (US); James A. Jorasch, Stamford, CT (US); Russell P. Sammon, San Francisco, CA (US); Steven M. Santisi, Ridgefield, CT (US); Victor M. Garcia, New Haven, CT (US)

Correspondence Address: WALKER DIGITAL, 2 HIGH RIDGE PARK, STAMFORD, CT, 06905, US

(21) Appl. No.: 10/639,090

(22) Filed: Aug. 12, 2003

Related U.S. Application Data
(60) Provisional application No. 60/403,186, filed on Aug. 12, 2002.

(51) Int. Cl. G06T 1/00; G06F 17/24

(52) U.S. Cl. 345/418; 715/530

(57) ABSTRACT

The invention provides a digital picture frame that allows a user to edit a displayed picture using simple and intuitive controls. Modifications to an image may be stored by the digital picture frame so that the digital picture frame may later display the edited or modified version of the picture rather than the original version. A user may edit a picture using mechanical controls (e.g., knobs, switches, slider-bars, wheels), sensors (e.g., a position sensor, a tilt sensor, a microphone, a light sensor), a voice recognition module, and/or a touch screen. A digital picture frame may identify a user and based on the user's identity (e.g., the user's preferences or permissions), may display pictures to the user. Further, different users may modify a picture in different ways, so that two different users may view two different versions of the same picture.

### RELATED APPLICATIONS

This application claims priority to commonly-owned, co-pending U.S. Provisional Patent Application Ser. No. 60/403,186, filed Aug. 12, 2002, entitled “Digital Picture Frame and Method for Editing” which is incorporated by reference in its entirety for all purposes.

### FIELD OF THE INVENTION

The present invention relates to digital picture frames. More specifically, the present invention relates to digital picture editing and display methods and apparatus for displaying and editing digital pictures.

### BACKGROUND OF THE INVENTION

While there are a number of commercially available conventional digital picture frames, none of them allow a user to simply and easily edit and store a displayed image (e.g., U.S. Pat. No. 6,442,573 to Schiller et al. describes conventional digital picture frames and is hereby incorporated herein by reference for all purposes.) Currently, the only available means to edit an image requires the use of a general purpose personal computer executing an image editing application. Such prior art systems are typically too involved, too cumbersome and too complicated for the average consumer. Therefore, what is needed are systems and methods that facilitate picture editing functions in a simple, straight forward, convenient, and easy to use manner.

### BRIEF DESCRIPTION OF THE DRAWINGS

FIG. 1 is a block diagram illustrating an example digital picture frame according to some embodiments of the present invention.

FIG. 2 is a diagram illustrating an example of the external appearance of a digital picture frame that includes controls according to some embodiments of the present invention.

FIG. 3 is a table illustrating an example data structure of an example picture database for use in some embodiments of the present invention.

FIGS. 4A and 4B are a table illustrating an example data structure of an example user database for use in some embodiments of the present invention.

FIG. 5 is a table illustrating an example data structure of an example picture modification database for use in some embodiments of the present invention.

FIG. 6 is a flow diagram illustrating an exemplary process for editing a displayed image according to and for use in some embodiments of the present invention.

### DETAILED DESCRIPTION OF EMBODIMENTS OF THE INVENTION

The invention overcomes the above and other drawbacks of the prior art by providing a digital picture frame that allows a user to edit a picture displayed on the digital picture frame. For example, a user may edit a picture using various controls on the digital picture frame, including mechanical controls (e.g., knobs, switches, slider-bars, wheels), sensors (e.g., position sensors, tilt sensors, microphones, light sensors), a voice recognition module, and/or a touch screen. More specifically, a digital picture frame may include dedicated mechanical slider control bars for adjusting the vertical and horizontal cropping of a digital picture, knobs for adjusting brightness, contrast, hue, and saturation of a digital picture, and a microphone and speaker that may be part of a voice recognition module.

A digital picture may be edited in a variety of ways in accordance with the present invention. For example, the different ways of modifying a picture may include geometric transformations (e.g., cropping, rotating, zooming in and out), pixel transformations (e.g., brightness, contrast, hue, saturation), filters (e.g., sharpen, soften, emboss, remove shadows), image manipulation (e.g., combining two pictures, removing an object from a picture), and meta-data changes (e.g., adding annotations of who is in a picture, when and where a picture was taken).

According to the present invention, any modifications to an image may be stored by a digital picture frame along with the image so that in the future, the digital picture frame may display the edited or modified version of the picture rather than the original version of the picture. In some embodiments, different users may modify a picture in different ways, so that two different users may view two different versions of the same picture.

According to some embodiments, a digital picture frame may identify a user. Based on the user's identity (e.g., the user's preferences or permissions), the digital picture frame may display pictures to the user or enable the user to edit pictures using the digital picture frame. For example, a user may have certain photos that are private (e.g., not viewable by other viewers) or pictures (e.g., artwork) that he would prefer not be edited by other users.

According to some embodiments, a digital picture frame may communicate with one or more other devices (e.g., a computer server). This communication may be encrypted to prevent attackers from viewing pictures, modifying pictures, or performing other undesirable activities relating to a digital picture frame. For example, encryption may be used to prevent attackers from duplicating copyrighted photos that are displayed on a digital picture frame.

According to the present invention, editing and manipulating pictures is simplified to such a degree that any user may edit pictures. A user no longer needs to own a general purpose computer, nor to understand how to operate a computer, to edit a picture. Mechanical controls make it easy and intuitive for a user to edit a picture using a digital picture frame of the present invention. In some embodiments, voice recognition allows a user to edit a picture using the digital picture frame of the present invention. Identifying a user enables personalization of display preferences and editing functions. For example, pictures may be displayed based on a user's identity. Further, different users may make different modifications to the same picture. Encryption may be used to ensure privacy and prevent illicit use of a digital picture frame according to the present invention. Private digital pictures may be kept private. Copyrighted digital pictures displayed on the frame may be protected from duplication or alteration. Users or attackers may not be able to edit pictures without permission

With these and other advantages and features of the invention that will become hereinafter apparent, the nature of the invention may be more clearly understood by reference to the following detailed description of the invention, the appended claims and to the several drawings included herein.

In the following description, reference is made to the accompanying drawings that form a part hereof, and in which is shown, by way of illustration, specific embodiments in which the invention may be practiced. These embodiments are described in sufficient detail to enable those skilled in the art to practice the invention, and it is to be understood that other embodiments may be utilized and that structural, logical, software, hardware, and electrical changes may be made without departing from the scope of the present invention. The following description is, therefore, not to be taken in a limited sense, and the scope of the present invention is defined by the appended claims.

A. Terms

Throughout the description that follows and unless otherwise specified, the following terms may include and/or encompass the example meanings provided in this section. These terms and illustrative example meanings are provided to clarify the language selected to describe embodiments of the invention both in the specification and in the appended claims.

The terms “picture” and “image” shall be synonymous and may refer to any design or representation made by various means (as painting, drawing, or photography).

The terms “digital picture” and “digital image” shall be synonymous and may refer to a digital representation of an image and may be composed of at least one pixel. Information representative of a digital image may be stored in a memory device in the form of binary data. Note that various different types of digital pictures are possible, including photographs, artwork (e.g., generated with Adobe® Illustrator®), and diagrams (e.g., a floor plan of a building). The term digital picture may refer to a multi-dimensional image, including 2-dimensional, 2.5-dimensional, and 3-dimensional images. A digital image may be a 2-dimensional array of pixels, or information that is suitable in determining a 2-dimensional array of pixels.

The term “photography” may refer to the art or process of producing images on a sensitized surface (as a film or electronic sensors) by the action of radiant energy and especially light.

The term “digital photo” may refer to a digital picture generated via photography.

The term “digital picture frame” may refer to a device whose dimensions are similar to a conventional picture frame and whose function is limited to displaying and editing digital pictures.

The term “control” may refer to a device, mechanism, or process that enables a user to regulate or guide one or more aspects of the operation of a digital picture frame. A control may include a device or representation associated with and/or for controlling a single dedicated function or it may include a physical device associated with and/or for controlling a plurality of functions that depend upon an operating mode or context.

The term “mechanical control” may refer to a physical mechanism that enables a user to regulate or guide an aspect of the operation of a digital picture frame. Mechanical controls are a subset of controls.

The term “edit control” may refer to a control that enables a user to regulate or guide a modification of an image displayed on a digital picture frame as well as a modification of the information representative of the digital image. The modification of the digital image may be saved so that future viewing of the modified digital image on any digital picture frame will include the modification. Thus, an edit control, distinct from a control that merely alters a display characteristic for all displayed images, modifies the binary data of a particular digital image and saves the modified binary data.

The term “user” may refer to any person or entity that operates a digital picture frame. A user may view pictures or edit pictures using a digital picture frame.

The term “viewer” may refer to a user who views pictures on a digital picture frame. Note that viewer is a subcategory of user.

The terms “server,” “computer server” and “image server” shall be synonymous and may refer to any device that may communicate with one or more digital picture frames, one or more third-party servers, one or more remote controllers, one or more user devices, and/or other network nodes, and may be capable of relaying communications including digital images to and from each.

The terms “user terminal,” “computer,” and “remote controller” shall be synonymous and may refer to any general purpose device that may execute a variety of different applications and may communicate with one or more servers, one or more digital picture frames, one or more third-party service provider servers, one or more player devices, and/or other network nodes. User terminals may, for example, include personal computers, laptop computers, handheld computers, telephones, kiosks, automated teller machines, gaming devices, game consoles, and/or vending machines. They may include facilities to support secure communications using encryption or the like.

The term “input device” may refer to a device that is used to receive an input. An input device may communicate with or be part of another device (e.g. a digital picture frame, a point of sale terminal, a point of display terminal, a user terminal, a server, a player device, a gaming device, a controller, etc.). Some examples of input devices include: a memory stick reader, a mechanical control, a bar-code scanner, a magnetic stripe reader, a computer keyboard, a point-of-sale terminal keypad, a touch-screen, a microphone, an infrared sensor, a sonic ranger, a computer port, a video camera, a motion detector, a digital camera, a network card, a universal serial bus (USB) port, a GPS receiver, a radio frequency identification (RFID) receiver, a RF receiver, a thermometer, a pressure sensor, a motion sensor, and a weight scale.

The term “output device” may refer to a device that is used to output information. An output device may communicate with or be part of another device (e.g. a digital picture frame, a computer, a gaming device, a point of sale terminal, a point of display terminal, a player device, a controller, etc.). Some examples of possible output devices include: a cathode ray tube (CRT) monitor, liquid crystal display (LCD) screen, light emitting diode (LED) screen, a printer, an audio speaker, an infra-red transmitter, a radio transmitter.

The term “I/O device” may refer to any combination of input and/or output devices.

B. System

Prior art digital picture frames, also known as digital photo viewers, digital picture viewers, digital image viewers, digital photo receivers, and digital image frames, are typically shaped and sized similar to conventional picture frames. These prior art devices may include controls to operate basic display functions of the digital photo receivers, such as brightness, for example. However, because prior art digital picture viewers are merely picture viewers or receivers, they do not provide “edit controls” that allow a user to make modifications to digital images that are associated with the digital images such that the modified digital images are presented as modified when displayed in the future or on other digital picture frames.

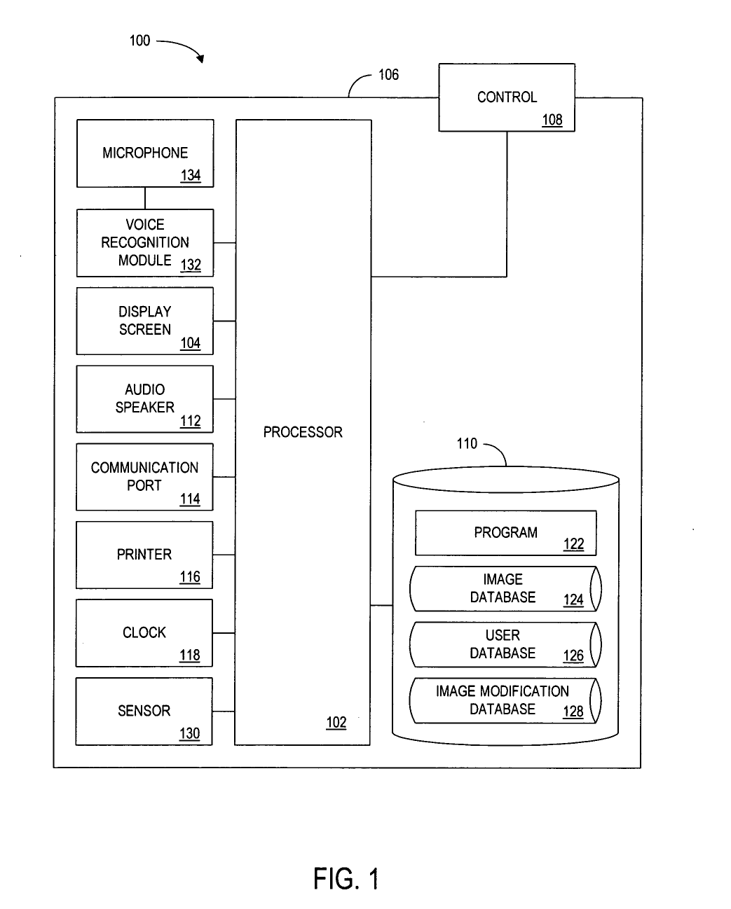

A digital picture frame of the present invention includes devices whose dimensions are similar to a conventional picture frame and whose function is limited to both displaying and editing digital pictures. Turning to FIG. 1, such a digital picture frame 100 may include one or more of the following: a processor 102 (e.g., a microcontroller or microprocessor); a display screen 104; a frame 106 including an enclosure or case for the other components; at least one control 108; a memory 110 storing a program 122 and databases 124, 126, 128; an audio speaker 112; at least one communication port or input device 114; a printer 116; a clock 118; and a hanger 120 (not pictured) (e.g., to hang the digital picture frame on a wall). In some embodiments, a digital picture frame may include a sensor 130 and/or a voice recognition module 132 and microphone 134.

Various different types of display screens 104 may be used including: a cathode ray tube (CRT) video monitor; a liquid crystal display (LCD) screen (including passive matrix and active matrix LCD screens); a light emitting diode (LED) screen (including organic and inorganic LEDs); a LCD projector display; an electronic ink display (e.g., such as one made by E Ink Corporation in Cambridge, Mass.); and/or a touch screen. A display screen 104 may output various information to a user, including: digital pictures; meta-data about digital pictures; and/or instructions for operation of the digital picture frame.

A control 108 may include a device, mechanism, or process that enables a user to regulate or guide the operation of a digital picture frame. A variety of different types of controls 108 are possible, including: a mechanical edit control; a sensor; a voice recognition module; and/or a touch screen. A mechanical edit control may be a mechanism that enables a user to regulate or guide the editing of a digital image displayed on a digital picture frame 100. Examples of mechanical edit controls include a slider, a knob, a button, a key, a wheel, a dial, a handle, and/or a switch.

A mechanical edit control 108 may include at least two parts: a base portion (e.g., which may be mounted to the digital picture frame 100) and a movable portion. Operating a mechanical edit control may include moving the movable portion of the mechanical control relative to the base portion of the mechanical control. Examples of mechanical edit controls include: a user may displace a slider bar (a movable portion) relative to a digital picture frame 100 to crop an image; a user may twist a knob (a movable portion) relative to a digital picture frame to modify the orientation of an image; and/or a user may press a button, thereby moving inwards relative to the case of a digital picture frame 100 to step through application of a series of digital filters. A user may operate a mechanical edit control on a digital picture frame 100 to perform various editing functions. For example, as suggested above, a user may use a slider bar on a digital picture frame 100 to control how a digital picture displayed in the frame is cropped.

A mechanical edit control may have a dedicated edit function on a digital picture frame 100 according to the present invention. That is, a control may perform one and only one function. For example, a knob on a digital picture frame 100 may control the editing of the brightness of a picture displayed in the digital picture frame 100. In some embodiments, a mechanical edit control may perform a plurality of functions on a digital picture frame 100. For example, up-down arrow keys on a digital picture frame 100 may control different aspects of a digital picture in different contexts of usage. Note that operating a control may include pushing the control (e.g., a button), twisting the control (e.g., a knob), turning the control (e.g., a wheel), flicking the control (e.g., a switch), moving the control (e.g., a slider), rotating the control (e.g., a track-ball), pressing the control, depressing the control (e.g. a spring loaded button), compressing the control, squeezing the control (e.g. a trigger), pulling the control (e.g. a handle), pinching the control, and/or grasping the control.

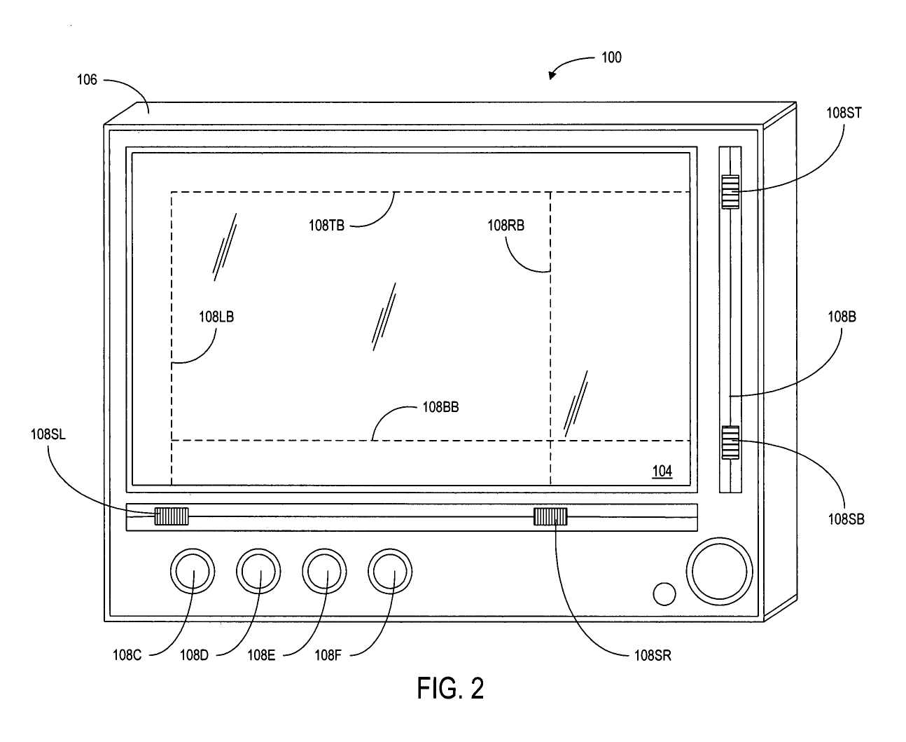

FIG. 2 illustrates a frontal view of a an example of a digital picture frame 100 according to some embodiments of the present invention. Note that slider controls 108A and 108B are positioned so as to provide an intuitive means to define boundaries for cropping a displayed image both horizontally and vertically. In other words, the left-hand moveable portion 108SL of slider control 108A may easily be used to specify a left-hand boundary 108LB within an image on the display screen 104 while the right-hand moveable portion 108SR of slider control 108A may easily be used to specify a right-hand boundary 108RB within a displayed image. Likewise, the upper moveable portion 108ST of slider control 108B may easily be used to specify an upper boundary 108TB within a displayed image while the lower moveable portion 108SB of slider control 108B may easily be used to specify a lower boundary 108BB within an image on the display screen 104. Knob and/or push button controls 108C, 108D, 108E, 108F may be used for any number of different functions including, for example, zooming in or out, stepping through application of digital filters, editing color and lighting characteristics, adding text to the image or meta-data, saving an edited version of an image, etc. Many other possible functions for various types of different mechanical controls are discussed in more detail below with respect to methods of the invention.

Returning to FIG. 1, a digital picture frame 100 of the present invention may include one or more sensors 130, 132, 134 that may be used to operate aspects of the digital picture frame's functions. A sensor may include devices that respond to a physical stimulus (as heat, light, sound, pressure, magnetism, or a particular motion) and transmit a resulting impulse (as for measurement or operating a control). Examples of sensors 130 include position sensors. For example, a digital picture frame may include a global positioning satellite (GPS) device or other location sensor that allows it to know its own location. The digital picture frame 100 may then (in response to the GPS signal) display photos based on its location (e.g., a child's bedroom, a kitchen). In a another example, a user may move a digital picture frame 100 in order to crop a picture. As the user moves the digital picture frame, the digital picture frame may automatically pan the display of the picture based on the user's movement of the frame. So if the user moves the digital picture frame one inch to the right, then the picture displayed in the frame will be shifted one inch to the left (e.g., thereby moving the left side of the picture out of the viewable area on the picture frame and cropping it off). A digital picture frame 100 may determine its position using dead-reckoning.

Likewise, an orientation sensor 130 such as the CXM113 3-Axis Analog Magnetometer manufactured by Crossbow Technology, Inc. in San Jose, Calif. may be used to sense the orientation of the digital picture frame 100 to enable the display of a large 360° picture. As the digital picture frame 100 is rotated, it may shift the displayed image so that an appropriate portion of the image is displayed corresponding to the orientation of the viewer's gaze. In other words, if the image includes the view in all directions of a person standing in the middle of a square room, a digital picture frame 100 that displays images based on the orientation of the digital picture frame 100 would show a picture of the ceiling of the room if the digital picture frame 100 was held face down and a picture of the floor of the room if the digital picture frame was held face up. (360-degree-by-360-degree “immersive images” can be generated using commercially available software and cameras from iPIX® Internet Pictures Corporation in Oak Ridge, Tenn.)

Other sensors that may be used include: a microphone 134 (note that a microphone 134 may be part of, or be otherwise associated with a voice recognition module 132); pressure sensor (e.g., an altimeter); a force sensor (e.g., a tilt sensor in the digital picture frame may allow the digital picture frame to determine its own orientation relative to gravity and thereby automatically switch from displaying pictures vertically to displaying pictures horizontally); an acceleration sensor; a velocity sensor; a light sensor (e.g., a digital picture frame 100 may automatically turn itself off when the lights in a room are turned off or a digital picture frame 100 may automatically adjust the brightness of a display screen based on the amount of ambient light in a room); a digital camera (e.g., a digital picture frame may use image recognition to monitor its surroundings and determine information like how many people are in a room or the identity of a person in the room); a temperature sensor; a magnetic field sensor; a voltage sensor (e.g., a touch screen may use voltage sensors to determine where a user touches the display screen 104); a current sensor (e.g., a touch screen may use current sensors to determine where a user touches the display screen 104); a radio antenna (e.g., a digital picture frame 100 may include a radio antenna for communicating with other devices like computers, personal digital assistants, printers, and radio frequency identification (RFID) cards); a biological or chemical voltage probe; a compass (e.g., an electronic compass); and/or a biometric sensor (e.g., a fingerprint reader, a camera with facial recognition capability, a retinal scanner, a DNA sequencer).

Note that sensors 130 on a digital picture frame 100 may be used for a variety of different purposes including: receiving inputs to a digital picture frame (e.g., a digital picture frame 100 may use a biometric sensor to identify a user, or an acceleration sensor to determine if a user accidentally drops the digital picture frame on the ground); and/or monitoring a digital picture frame's environment (e.g., a digital picture frame 100 may use a digital camera and a microphone to determine whether there is a party going on in a room where it is located, or a digital camera to determine what type of room it is located in (e.g., a hallway, or a kitchen) or determine if someone is walking by.

In some embodiments, a digital picture frame 100 may include a voice recognition module 132. This voice recognition module 132 may include one or more of the following: at least one microchip, a computer program, and a microphone 134. A voice (or speech) recognition module 132 in a digital picture frame 100 may enable the digital picture frame 100 to receive and process voice commands from a user. Voice recognition software is known to those skilled in the art and need not be described herein. Examples of voice recognition software include: OpenSpeech from Speechworks International; Nuance 8.0 from Nuance Communications; ViaVoice from IBM Voice Systems; and Dragon Naturally Speaking from Dragon Systems.

A touch screen may be used as a display screen 104 that also functions as a control 108. Touch screens are known to those skilled in the art and need not be described in detail herein. Various touch screen technologies are possible, including resistive touch screens, infrared touch screens, acoustic wave touch screens, and/or capacitive touch screens. A user may use a stylus or other implement to operate a touch screen. Examples of touch screen manufacturers include Elo TouchSystems, 3M Touch Systems, Touch Controls, Inc., Digitech Systems, and/or CyberTouch.

A digital picture frame 100 may include at least one communication port (or input device) 114 suitable for communicating with other devices to receive digital pictures for display. For example, a communication port on a digital picture frame may be used to: receive pictures from a computer on the World Wide Web (e.g., a website); receive pictures from a digital camera; send pictures to a computer on the World Wide Web (e.g., a website); send pictures to a digital camera; and/or retrieve and store digital images from/to a memory stick. A communication 114 port may connect a digital picture frame 100 to a communication network. Possible communication networks include: a local area network (LAN), a wide area network (WAN), the Internet, a telephone line, a cable line, a radio channel, an optical communications line, a satellite communications link. Communication through a communication port 114 may use at least one communication protocol. Possible communications protocols include: Ethernet, Bluetooth, TCP/IP, USB, and/or Firewire. Communication may be encrypted to ensure privacy and prevent fraud.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks or months at a time.

In some embodiments, a digital picture frame may include a printer 116. Examples of printers include an ink-jet printer, a laser printer, a dot-matrix printer, and/or a thermal printer. A printer 116 may be particularly useful in printing a picture for a user. For example, a user may press a button or other control 108 on a digital picture frame 100 to print a copy of a picture that he can carry in his wallet or give to a friend. According to some embodiments, a printer 116 may be included in a digital picture frame 116. Alternatively, a digital picture frame may be connected to a printer using a cable or other communications link (e.g., an infra-red communications link).

A digital picture frame 100 may include volatile or non-volatile memory 110, or a combination thereof. This memory may be electronic, capacitive, inductive, or magnetic in nature. Examples of memory 110 may include any appropriate combination of magnetic, optical and/or semiconductor memory, and may include, for example, additional processors, communication ports, Random Access Memory (“RAM”), Read-Only Memory (“ROM”), a compact disc, DVD drive, and/or a hard disk. Memory 110 may be used for storing information such as program instructions, encryption keys (e.g., a secret key), an image database 124, a user database 126, and/or an image modification database 128. These example databases are discussed in detail below. Information stored in the memory 110 of a digital picture frame 100 may be encrypted to ensure privacy, restrict copying, and prevent fraud.

The memory 110 may store a program 122 for controlling the processor 102. The processor 102 performs instructions of the program 122, and thereby operates in accordance with the present invention, and particularly in accordance with the methods described in detail herein. Portions of the present invention may be embodied as a program 122 developed using an object oriented language that allows the modeling of complex systems with modular objects to create abstractions that are representative of real world, physical objects and their interrelationships. However, it would be understood by one of ordinary skill in the art that the invention as described herein can be implemented in many different ways using a wide range of programming techniques as well as general purpose hardware sub-systems or dedicated controllers. The program 122 may be stored in a compressed, uncompiled and/or encrypted format. The program 122 furthermore may include program elements that may be generally useful, such as an operating system, a database management system and device drivers for allowing the processor 102 to interface with computer peripheral devices. Appropriate general purpose program elements are known to those skilled in the art, and need not be described in detail herein.

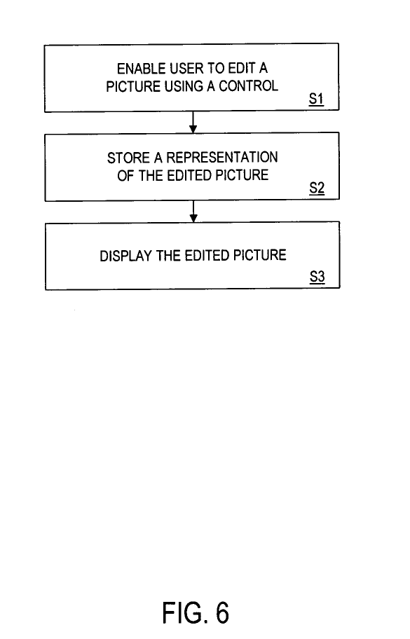

Further, the program 122 is operative to execute a number of invention-specific, objects, modules and/or subroutines which may include (but are not limited to) one or more routines to respond to mechanical edit controls to edit digital images; one or more routines to respond to controls 108, including sensors, to control the operation of the digital picture frame 100; one or more routines to receive digital images; one or more routines to store digital images; one or more routines to store modifications of digital images and associate the stored modifications with the corresponding digital image; and/or one or more routines to control databases or software objects that track information regarding users, images, and modifications of images. Examples of these routines and their operation are described below in conjunction with the flowchart depicted in FIG. 6.

According to some embodiments of the present invention, the instructions of the program 122 may be read into a memory 110 of the processor 102 from another medium, such as from a ROM to a RAM. Execution of sequences of the instructions in the program 122 causes processor 102 to perform the process steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software.

In addition to the program 122, the memory 110 is also operative to store (i) an image database 124, (ii) a user database 126, and (iii) an image modification database 128. The databases 124, 126, 128 are described below and example structures are depicted with sample entries in the accompanying figures. As will be understood by those skilled in the art, the schematic illustrations and accompanying descriptions of the sample databases 124, 126, 128 presented herein are exemplary arrangements for stored representations of information. Any number of other arrangements may be employed besides those suggested by the tables shown. For example, even though three separate databases are illustrated, the invention could be practiced effectively using one, two, four, or more functionally equivalent databases. Similarly, the illustrated entries of the databases represent exemplary information only; those skilled in the art will understand that the number and content of the entries can be different from those illustrated herein. Further, despite the depiction of the databases as tables, an object-based model could be used to store and manipulate the data types of the present invention and likewise, object methods or behaviors can be used to implement the processes of the present invention. These processes are described below with respect to FIG. 6.

C. Databases

As indicated above, it should be noted that although the example embodiment depicted in FIG. 1 includes three particular databases stored in memory 110, other database arrangements may be used which would still be in keeping with the spirit and scope of the present invention. In other words, the present invention could be implemented using any number of different database files or data structures, as opposed to the three depicted in FIG. 1. Further, the individual database files could be stored on different devices (e.g. located on different storage devices in different geographic locations, such as on a third-party image server). Likewise, the program 122 could also be located remotely from the memory 110 and/or on another server. As indicated above, the program 122 may include instructions for retrieving, manipulating, and storing data in the databases 124, 126, 128, as may be useful in performing the methods of the invention as will be further described below.

1. Image Database

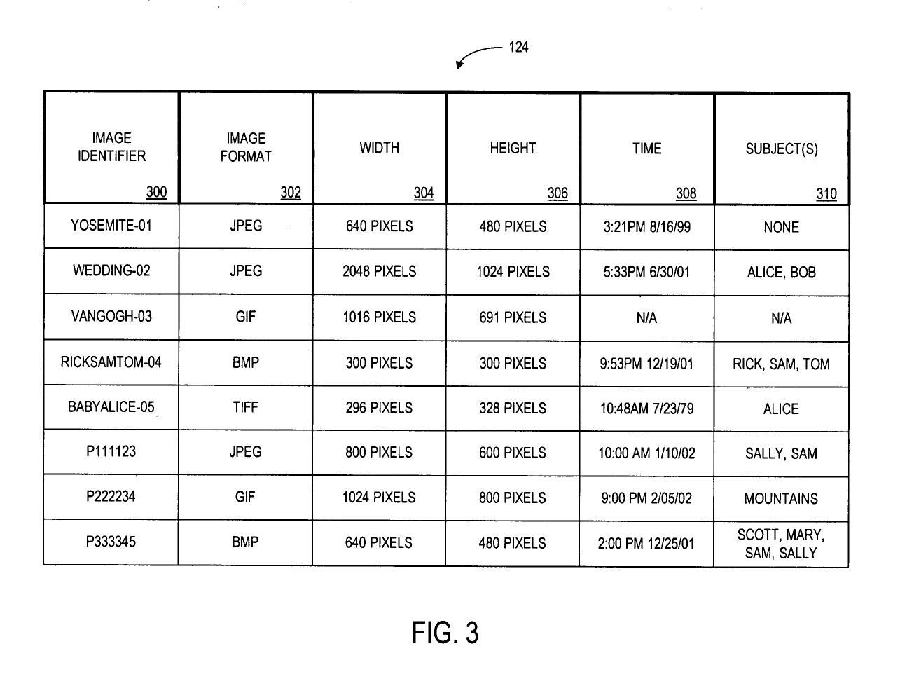

Turning to FIG. 3, a tabular representation of an embodiment of an image database 124 according to some embodiments of the present invention is illustrated. This particular tabular representation of an image database 124 includes eight sample records or entries which each include information regarding a particular image. In some embodiments of the invention, an image database 124 is used to track such things as image data and characteristics of the image. Those skilled in the art will recognize that such an image database 124 may include any number of entries or additional fields.

The particular tabular representation of an image database 124 depicted in FIG. 3 includes six fields for each of the entries or records. The fields may include: (i) an image identifier field 300 that stores a representation uniquely identifying the image and may also serve as a pointer to a storage location of the actual image data within the memory 110; (ii) an image format field 302 that stores a representation of a format of the image; (iii) a width field 304 that stores a representation of the image's width; (iv) a height field 306 that stores a representation of the image's height; (v) a time field 308 that stores a representation of the time/date the image was created; and (vi) a subject(s) field 310 that stores a representation of a description of people or subjects depicted in the image.

The example image database 124 depicted in FIG. 3 provides example data to illustrate the meaning of the information stored in this database embodiment. An image identity 300 (e.g. “YOSEMITE-01,” “WEDDING-02,” “VANGOGH-03,” “RICKSAMTOM-04,” “BABYALICE-05,” “P111123,” “P222234,” “P333345”) may be used to identify and index the images listed in the image database 124. Eight examples of image information are provided in FIG. 3 and the last three examples are described here. Image number “P111123” is a “JPEG” that is “800 PIXELS” by “600 PIXELS.” It was created “10:00 AM Jan. 10, 2002” and it depicts “SALLY, [and] SAM.” Image number “P222234” is a “GIF” that is “1024 PIXELS” by “800 PIXELS.” It was created “9:00 PM Feb. 5, 2002” and it depicts “MOUNTAINS.” Image number “P333345” is a “BMP” that is “640 PIXELS” by “480 PIXELS.” It was created “2:00 PM Dec. 25, 2001” and it depicts “SCOTT, MARY, SAM, [and] SALLY.”

2. User Database

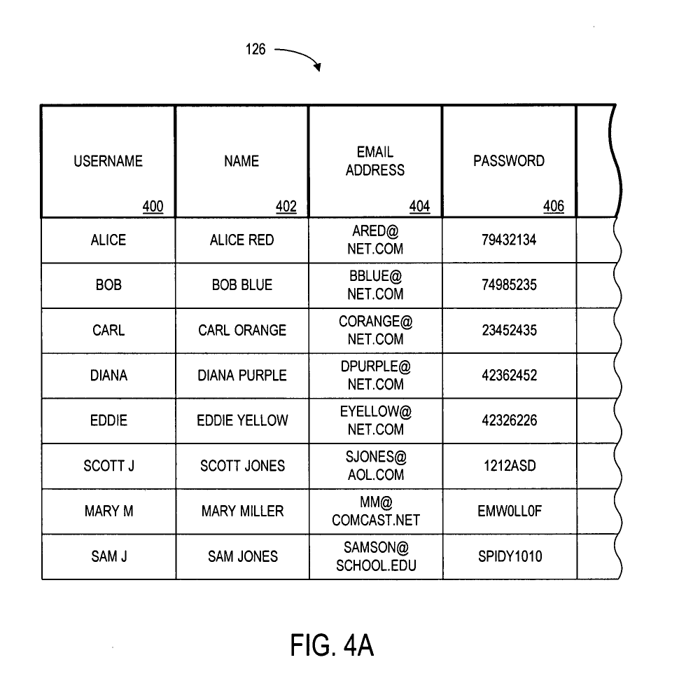

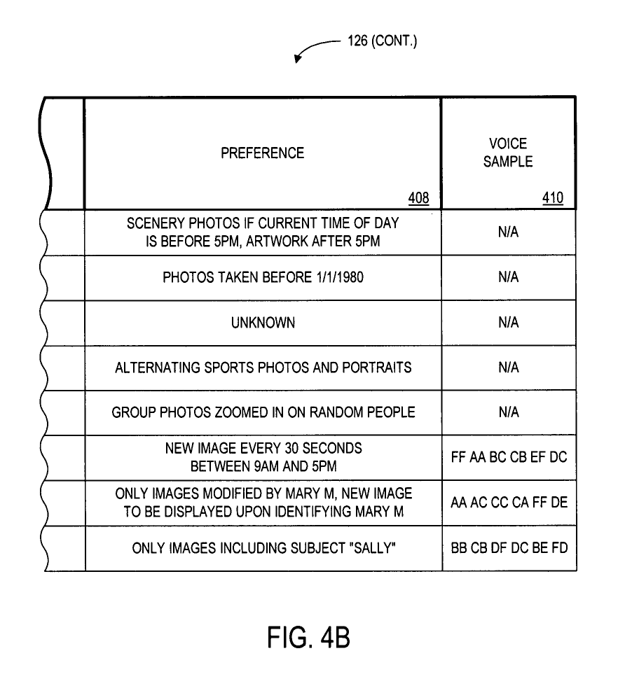

Turning to FIGS. 4A and 4B, a tabular representation of an embodiment of a user database 126 according to some embodiments of the present invention is illustrated. This particular tabular representation of a user database 126 includes eight sample records or entries which each include information regarding a particular user. In some embodiments of the invention, a user database 126 is used to track such things as user identity and preferences. Those skilled in the art will recognize that such a user database 126 may include any number of entries or additional fields.

The particular tabular representation of a user database 126 depicted in FIGS. 4A and 4B includes six fields for each of the entries or records. The fields may include: (i) a username field 400 that stores a representation uniquely identifying the user; (ii) a name field 402 that stores a representation of the user's actual name; (iii) an email address field 404 that stores a representation of the user's email address; (iv) a password field 406 that stores a representation of the user's password; (v) a preference field 408 that stores a representation of the user's preferences; and (vi) a voice sample field 410 that stores a representation of the characteristics of the user's voice that may be used by the digital picture frame 100 to identify the user.

The example user database 126 depicted in FIGS. 4A and 4B provides example data to illustrate the meaning of the information stored in this database embodiment. A user name field 400 (e.g “ALICE,” “BOB,” “CARL,” “DIANA,” “EDDIE,” “SCOTT J,” “MARY M,” “SAM J”) may be used to identify and index the users listed in the user database 126. Eight examples of user information are provided and the last three entries are described here. “SCOTT JONES” with an email address of “SJONES@AOL.COM” has a password “1212ASD” and prefers a new digital image to be displayed “EVERY 30 SECONDS BETWEEN 9 AM AND 5 PM.” To determine Scott's presence, the digital picture frame 100 listens for a voice print that encodes as “FF AB BC CB EF DC.” “MARY MILLER” with an email address “MM@COMCAST.NET” has a password “EMWOLLOF” and prefers “ONLY IMAGES MODIFIED BY MARY M, [with a] NEW IMAGE TO BE DISPLAYED UPON [being] IDENTIF[ied].” To determine Mary's presence, the digital picture frame 100 listens for a voice print that encodes as “AA AC CC CA FF DE.” “SAM JONES” with an email address “SAMSON@SCHOOL.EDU” has a password “SPIDY1010” and prefers “ONLY IMAGES INCLUDING SUBJECT ‘SALLY’,” his girlfriend, be displayed when he is detected by the digital picture frame 100. To determine Sam's presence, the digital picture frame 100 listens for a voice print that encodes as “BB CB DF DC BE FD.”

3. Image Modification Database

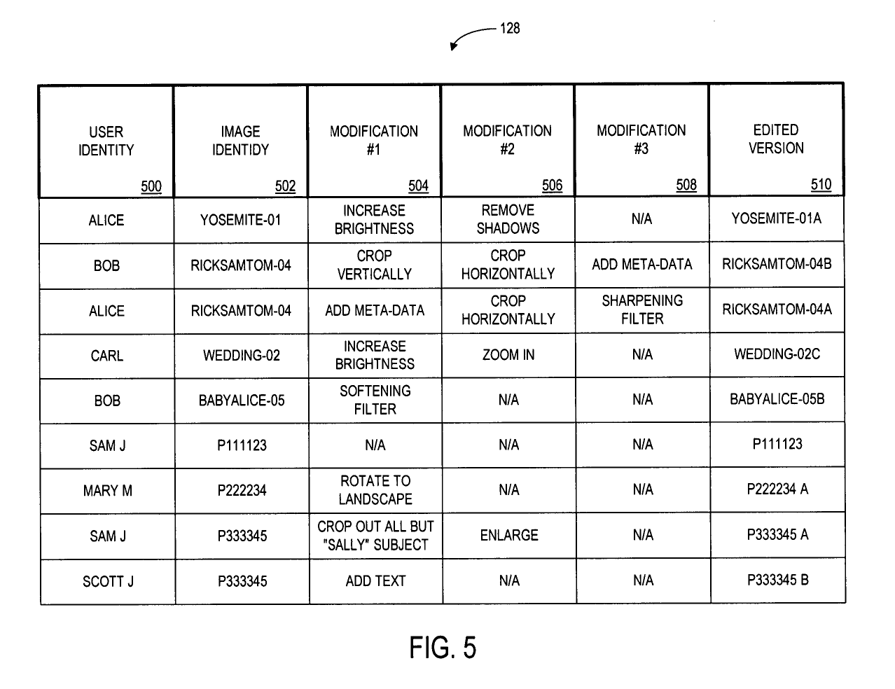

Turning to FIG. 5, a tabular representation of an embodiment of an image modification database 128 according to some embodiments of the present invention is illustrated. This particular tabular representation of an image modification database 128 includes nine sample records or entries which each include information regarding particular modifications of an image. In some embodiments of the invention, an image database 128 is used to track such things as multiple image modifications by a particular user. Those skilled in the art will recognize that such an image database 128 may include any number of entries or additional fields.

The particular tabular representation of an image modification database 128 depicted in FIG. 5 includes six fields for each of the entries or records. The fields may include: (i) an user identity field 500 that stores a representation uniquely identifying the user who modified (or originally loaded) the image; (ii) an image identity field 502 that stores a representation uniquely identifying the image; (iii) a first modification field 504 that stores a representation of a first modification made to the image; (iv) a second modification field 506 that stores a representation of a second modification made to the image; (v) a third modification field 508 that stores a representation of a third modification made to the image; and (vi) an edited version field 510 that stores a representation of data representative of a pointer to the edited version of the image.

The example image modification database 128 depicted in FIG. 5 provides example data to illustrate the meaning of the information stored in this database embodiment. Nine examples of image modifications are provided and the last four are described here. A user name field 500 (e.g. “SAM J,” “MARY M,” “SAM J,” “SCOTT J”) may be used to identify the user who either originally loaded the image into the digital picture frame 100 or modified the corresponding identified image (e.g. “P111123,” “P222234,” “P333345,” “P333345”). Thus, in these examples, Sam loaded image P111123 and Mary edited image P222234 by rotating it to a landscape orientation. Sam cropped out all subjects except Sally from P333345 and then enlarged the resulting image. Meanwhile, Scott added a text message to the original version of image P333345.

D. PROCESS

The system discussed above, including the hardware components and the databases, are useful to perform the methods of the invention. However, it should be understood that not all of the above described components and databases are necessary to perform any of the present invention's methods. In fact, in some embodiments, none of the above described system is required to practice the present invention's methods. The system described above is an example of a system that would be useful in practicing the invention's methods. For example, the user database 126 described above with respect to FIGS. 4A and 4B is useful for tracking users and information about them, but it is not absolutely necessary to have such a database in order to perform the methods of the invention. In other words, the methods described below may be practiced using, for example, a set of generic user preference slots that are numbered, e.g., one to four and a user simply associates himself with which ever generic user preference slot is available to store his preferences.

Referring to FIG. 6, a flow chart is depicted that represents some embodiments of the present invention that may be performed using the digital picture frame 100 (FIG. 1) or other device. It must be understood that the particular arrangement of elements in the flow chart of FIG. 6, as well as the number and order of example steps of various methods discussed herein, is not meant to imply a fixed order, sequence, quantity, and/or timing to the steps; embodiments of the present invention can be practiced in any order, sequence, and/or timing that is practicable.

In general terms and referring to FIG. 6, method steps of an embodiment of the present invention may be summarized as follows. In Step S1, a user is enabled to edit a picture using a control. In Step S2, a representation of the edited picture is stored. In Step S3, the edited picture is displayed.

In the subsections that follow, each of these steps will now be discussed in greater detail. Note that not all of these steps are required to perform the method of the present invention and that additional and/or alternative steps are also discussed below. Also note that the above general steps represent features of only some of the embodiments of the present invention and that they may be re-ordered, combined and/or subdivided in any number of different ways so that methods of the present invention include more or fewer actual steps. For example, in some embodiments many additional steps may be added to update and maintain the databases described above, but as indicated, it is not necessary to use the above described databases in all embodiments of the invention. In other words, the methods of the present invention may contain any number of steps that are practicable to implement the several different inventive processes described herein.

1. Editing a Picture Using a Control

Step S1, editing a picture using a control 108 of the digital picture frame 100 of the present invention, may include making a modification or alteration to the image. For clarity, the terms “a modification,” “an edit,” and “an alteration” are synonymous and are used to refer to any change that may be made to a digital picture. Different types of modifications to pictures include geometric transformations, pixel transformations, filters, image manipulation, meta-data changes, and text annotation. Examples of geometric transformations include horizontal cropping, vertical cropping, rotating a picture (e.g., clockwise or counterclockwise), zooming in/out on a portion of a picture (a.k.a. scaling), and cropping a picture to a predetermined aspect ratio or to a predefined boarder shape. For example, a user may desire to crop a picture so that it may be printed out and included in a standard photo album. Therefore, the horizontal and vertical cropping controls on the digital picture frame may be locked to a fixed aspect ratio (e.g., 2:3 or 3:5) so that a user may easily crop one or more photos to an appropriate size for printing on glossy paper. In addition a user may wish to print a picture to fit a conventional oval-shaped frame. Therefore, the horizontal and vertical cropping controls on the digital picture frame may be set to control the major and minor axes of an ellipse so that a user may easily crop a picture in an oval shape to match the conventional frame.

Examples of pixel transformations include brightness, contrast, hue, saturation, infra-red (e.g., for a camera that captures infra-red image information), range (e.g., for a digital camera that captures a range value for each pixel as in a 2.5-dimensional photo). Examples of filters include red-eye reduction, sharpen edges, soften edges, emboss, strobe, add shadow, remove shadow, colorize, sepia effect, tinting, toning, mosaic, pixeling, slimming, lith, compression, distortion, diffusion, and coarse grain effects.

Examples of image manipulation include: removing a person/object from a picture; adding an element of a second photo (e.g., insert Bob into the picture next to Alice); adding a animated portion to an image (e.g. moving eyeballs on an otherwise stationary head); modifying the background of a photograph (e.g., a user may change the background of a photograph from a picture of a dusty prairie to a picture of the Grand Canyon); combining a plurality of pictures into a single picture (e.g., a user may create a collage from a plurality of photos of her family members or create a sandwich or overlay effect using semi-transparent pictures); morphing to combine two photos; modifying a picture based on another picture (e.g., a user may specify that the brightness in a first picture should be set equal to the brightness in a second picture, or specify a plurality of modifications to a first picture and then use a single command to apply this plurality of modifications to a second picture); and/or extracting a portion of a picture and making it into a new picture (e.g., a digital picture frame may display a picture of three people (Rick, Sam, and Tom), a user may extract a portion of the picture (just Rick and Sam), and make this into a new picture). These new, edited pictures may be stored in an image database as illustrated in FIG. 3.

Examples of meta-data include: the time when picture was taken; the time when picture was uploaded from a digital camera or computer or memory stick; the source of the digital picture; the time when the picture was downloaded into the digital picture frame 100, the location where the picture was taken; the orientation of the camera when the picture was taken; the subjects of the picture (e.g., people, objects, locations, animals, etc); the identity of the photographer; notes from photographer (e.g., “trying to get a picture of baby with eyes open”); a telephone number of a subject in a picture. (e.g., a digital picture frame may include telephone capability, that allows a user to initiate a phone call based on a telephone number associated with a picture, for example, a grandmother may be able to telephone her grandson by pressing a button on digital picture frame when a picture of her grandson is being displayed); and changes that have been made to a picture (e.g., meta-data may include a description of how a picture has been edited by a user, such as a list of modifications).

A user may edit a plurality of pictures at one time. For example, a plurality of photographs may have been taken in the same location, which may have had poor lighting conditions. Rather than editing each photograph individually, a user may provide a single set of modifications and these modifications may be applied to the plurality of photographs.

A user may edit a picture based on one or more previous modifications to the picture. For example, an “undo” function may enable a user to reverse one or more previous modifications to a picture. In some embodiments, a digital picture frame 100 may display information that helps a user to edit a picture.

A user of a digital picture frame 100 may operate one or more controls on the digital picture frame to edit a picture. A variety of different types of controls are possible and a variety of different methods of editing a picture, as described above, are possible. An example of using at least one control on a digital picture frame 100 to edit a photo includes cropping a picture using slider bar controls. As depicted in FIG. 2, a digital picture frame 100 may include four slider bars, two oriented vertically 108ST, 108SB and two oriented horizontally 108SL, 108SR, on two slider controls 108A, 108B. These slider bars 108ST, 108SB, 108SL, 108SR may be used to crop a picture that is displayed in the digital picture frame 100. For example, the first slider bar 108ST may be used to set the upper crop limit 108TB for the picture, the second slider bar 108SB may be used to set the lower crop limit 108BB for the picture, the third slider bar 108SL may be used to set the left crop limit 108LB for the picture, and the fourth slider bar 108SR may be used to set the right crop limit 108RB for the picture.

In some embodiments, a knob 108C on a digital picture frame 100 may be used to adjust the brightness of a picture displayed in the digital picture frame 100.

In some embodiments, a user may use spoken commands to apply filters to a digital picture that is displayed in a digital picture frame 100. For example, a user may say “Soften Photo” to run a softening filter on a digital photo that is displayed in a digital picture frame 100.

In some embodiments, a user may use a touch screen to remove shadows from a photograph. For example, a user may use a stylus to select an area of a photograph where a shadow exists (e.g., one side of a person's face) and then press a button 108F on the digital picture frame 100 to remove the shadow from this area.

In some embodiments, a user may use a spoken command “Make picture number eighteen look like picture number seventeen.” Based on this command, a picture identified as number eighteen may be edited so that it has the similar brightness, contrast, filtering, and cropping to a picture identified as number seventeen.

Enabling a user to edit a picture may include determining a modification and altering the picture based on the modification. Determining a modification may include: determining a modification desired by a user; receiving an indication of a modification; receiving an indication of a modification from a user; and/or determining a plurality of modifications. Altering the picture based on a modification may include: modifying a picture based on a modification; making a modification to a picture; editing a picture; and/or editing a picture based on a modification.

2. Storing a Representation of the Edited Picture

As described above, a user may make modifications to picture. In Step S2, information relating to these modifications may be stored in a database. Storing information relating to a modification may include storing an indication of a modification, storing the modification itself, saving a modification, storing a modified picture, and/or storing information in a database. Various information may be stored based on modifications to a picture made by a user, including: a list of one or more modifications; who made a modification (e.g., which user); a description of a modification; a reason for a modification (e.g., to emphasize the background in the photo); a result of a modification (e.g., a modified picture); a method of reversing the modification (e.g., darkening may be the reverse of brightening); and/or an unedited version of the picture (the “original” picture).

For example, an edited version of a picture may be stored in a database or both an edited version of a picture and an original version of the picture may be stored in a database. In some embodiments, a database may store an original version of a picture and a list of at least one modification to the original picture. In some embodiments, various meta-data may be appended to a file associated with a picture. In some embodiments, various users may modify a picture in different ways. For example, Alice may modify a photo of Rick, Sam, and Tom to crop Rick out of the photo, whereas Bob may modify the picture of Rob, Sam, and Tom to crop Tom out of the photo. Two different version of the modified photo may be stored, one based on Alice's modifications (i.e., showing just Sam and Tom) and one based on Bob's modifications (i.e., showing just Rick and Sam).

In some embodiments, original versions of pictures may be stored in a first database (e.g., on a computer server), and information about how pictures have been edited may be stored in second database (e.g., on the digital picture frame 100). In some embodiments, information relating to modifications of pictures may be stored in an image modification database 128, such as the one shown in FIG. 5. Note that, as shown in FIG. 5, different users may modify the same picture in different ways, so that there may be multiple edited versions of a given picture. Also note that users may modify images previously modified by other users.

3. Displaying the Edited Picture

In Step S3, the edited picture is displayed on the digital picture frame 100. Displaying a picture on the digital picture frame 100 may include outputting the picture using a display screen 104, using a display screen 104 to display the picture, and/or outputting the picture using a printer 116. A digital picture frame 100 may display a picture to a user at various times, including before it is edited, while it is being edited, and/or after is has been edited. In some embodiments, a digital picture frame 100 may display a picture in response to some stimuli or triggering condition, and/or based upon a user defined schedule or predefined program.

In addition to displaying a picture, in some embodiments, a digital picture frame 100 may output various other information associated with the picture, including: an associated sound or verbal message; play-back of an MPEG or video stream wherein the initially displayed picture is the first or a key image of the video stream; meta-data associated with the picture (e.g., a list of changes that a user has made may be displayed next to an edited version of a picture); information that helps a user to edit a picture; information about security of a picture (e.g., a first portion of a picture may be secure and a second portion of a picture may be insecure. A digital picture frame may highlight a portion of a picture that is insecure); and/or a message to a user (e.g., a digital picture frame may display a message to a user that the user's subscription to an online image gallery is about to expire or has expired. This message may include contact information for a service provider of the online image gallery. A message displayed by a digital picture frame may obscure a portion of picture displayed on the digital picture frame).

As indicated above, a digital picture frame may display information that helps a user to edit a picture. Examples include: one or more suggested modifications to the picture (e.g., if a picture is too dark, the digital picture frame may suggest that a user brighten the picture by turning the brightness control knob); a digital picture frame 100 may display a box or highlight a portion of a picture to show how the picture may be cropped; a meter may compare the brightness and contrast of two sections of a photo to help a user remove a shadow from the photo; a digital picture frame 100 may include a tutorial that instructs a user how to crop a picture; and/or a digital picture may include a control (e.g., a touch-screen graphical user interface (GUI) switch) that allows a user to easily jump back and forth between two versions of a picture (e.g., an edited version and the original version).

In some embodiments, displaying a picture may include one or more of the following: determining if the picture has been edited; determining an edited version of a picture; and/or displaying the picture based on the at least one modification. Determining an edited version of a picture may include retrieving the edited version of the picture from a database. For example, a digital picture frame 100 may access an image modification database 128 to determine an edited version of a picture. Determining an edited version of a picture may include one or more of the following: determining an original version of a picture; determining at least one modification; and/or determining an edited version of the picture based on the at least one modification. For example, a digital picture frame may access an image modification database 128 to determine what modifications have been made to a picture. Then the digital picture frame 100 may make these modifications to an original version of the picture to create the edited version of the picture. The edited version of the picture may then be output to a user.

E. Additional Embodiments of the Invention

In some embodiments, a digital picture frame 100 may identify a user of the digital picture frame. For example, a user may use a touch screen on a digital picture frame to enter in his name, password, user identification number, login, or other information identifying himself. In some embodiments, a digital picture frame 100 may include a fingerprint reader. A user may identify himself by pressing his thumb on the fingerprint reader. In some embodiments, a user may say his name aloud to the digital picture frame. Using a voice recognition module, the digital picture frame may recognize the user's name and identify the user.

In some embodiments, a digital picture frame may merely receive an indication of a user's identity. For example, the user may carry a radio frequency identification (RFID) card and use this RFID card to identify himself to the digital picture frame. When the user walks within ten feet of the digital picture frame, the digital picture frame may use a radio antenna to communicate with the RFID card and identify the user. This system may be particularly convenient because a user may identify himself by carrying an RFID card in his wallet.

In some embodiments, a digital picture frame 100 may use a sensor to identify a user. For example, a digital picture frame 100 may include a video camera. Using image recognition software, the digital picture frame may recognize a user (e.g., based on his facial features) and identify him. Likewise, a digital picture frame 100 may include a microphone 134 and a voice recognition module 132. Using voice recognition software, the digital picture frame may recognize a user (e.g., based on a pre-recorded voice sample 410 associated with him and stored in the user database 126) and identify him.

In some embodiments, a digital picture frame may identify multiple users. For example, Alice and Bob may both be viewing a digital picture frame 100 simultaneously. The digital picture frame 100 may identify both of them by communicating with Alice's RFID card and Bob's RFID card. In some embodiments, a user may be identified as part of a group of users. For example, a digital picture frame may have two groups of users: (a) adults and (b) children. The digital picture frame 100 may not identify each user uniquely; instead a user may only be identified as being part of the “adults” group or part of the “children” group.

In some embodiments, a digital picture frame may display one or more pictures to a user based on the user's identity or membership in a group or category. For example, pictures may be displayed based on a user's preferences. For example, pictures of Alice's wedding may be displayed when Alice is in the same room as the digital picture frame 100 or Alice may specify that pictures of her honeymoon are displayed whenever her husband Bob is in the room with the digital picture frame 100. An indication of a user's preferences may be stored in a user database 126, such as the one shown in FIGS. 4A and 4B. In another example, pictures may be displayed based on a user's permissions. For example, a digital picture frame 100 may prevent a picture from being displayed to a user if the user does not have permission to view the picture. For example, Bob's children may not have permission to view Bob's pictures from college. An indication of a user's permissions may also be stored in a user database 126, such as the one shown in FIGS. 4A and 4B.

In some embodiments, pictures may be displayed based on one or more modifications made by a user. For example, Alice may edit a photo of Rick, Sam, and Tom to remove Rick from the photo. When Alice views the photo in the future, a digital picture frame may automatically display the edited version of the photo to Alice (i.e., the version without Rick). Note that if the digital picture frame displays the photo to a second user (e.g., Bob), then the original version of the photo (i.e., the version that includes Rick) or a third version of the photo (e.g., based on modifications by Bob) may be displayed.

Note that in some cases, a digital picture frame 100 may have multiple simultaneous users and a first user's (e.g., Alice's) preferences or permissions may be different than a second user's (e.g., Bob's) preferences or permissions. When this occurs, a digital picture frame may determine which picture to display based on the preferences or permissions of a plurality of users. In some embodiments, users may specify to the digital picture frame 100 predefined rules that specify a priority system or other method to resolve conflicting preferences.

In some embodiments, a digital picture frame 100 may allow or prevent modifications to a picture based on user's identity. Examples include:

A user may not be permitted to edit a picture. For example, Alice may not have permission to edit Bob's pictures and therefore a digital picture frame may prevent Alice from editing Bob's pictures. The term “viewer” may be used to refer to a user who does not have permission to edit pictures.

A user may be permitted to edit a picture in some ways, but not others. For example, Alice may be permitted to adjust the brightness and contrast on Bob's photographs, but not to crop the photos.

One or more controls on a digital picture frame 100 may be enabled or disabled based on a user's identity. For example, the cropping sliders on a digital picture frame may be enabled whenever a user has permission to crop a picture. When Alice is viewing one of Bob's pictures, the cropping sliders on a digital picture frame 100 may be disabled.

Users with a certain characteristic may be allowed to edit photos while users without the characteristic may not be permitted to edit photos. For example, members of the Jones family may be able to edit pictures on a digital picture frame in the Jones household, but nobody else may be permitted to edit these pictures. Note that different users of a digital picture frame may have different permissions. For example, some users (e.g., “power users”) may be able to edit pictures, whereas other users (e.g., “viewers”) may only be able to view pictures.

As mentioned above, communication to or from a digital picture frame 100 may be encrypted. For example, information that is transmitted by a digital picture frame 100 may be encrypted; information that is received by a digital picture frame 100 may be encrypted; a digital picture frame 100 may encrypt information before transmitting it to another device; and/or a digital picture frame 100 may decrypt information that it receives from another device.

In the following discussion, the term “attacker” is used to refer to a party who may perform an undesirable activity relating to a picture frame (e.g., duplicating copyrighted pictures, viewing private pictures). For example, an attacker may hack into a wireless network that a digital picture frame 100 uses to communicate with a computer server.

A digital picture frame 100 may transmit information to other devices (e.g., a computer server with a large database of pictures). If this transmission is not encrypted, various attacks may be possible. For example, without encryption, an attacker might be able to read communications between a digital picture frame and another device. This may be undesirable if information communicated to/from a digital picture frame 100 is private, confidential, or copyrighted. For example, an attacker might intercept a picture that is transmitted to a digital picture frame 100 and post the picture on the World Wide Web.

Without encryption, an attacker might be able to forge communications from another device to a digital picture frame. For example, a computer server might transmit pictures to a digital picture frame for display on the digital picture frame 100. An attacker could insert political propaganda, lewd pictures, or advertisements into a stream of pictures that is displayed by the digital picture frame 100.

Further, without encryption, an attacker might be able to forge communications from digital picture frame 100 to another device. For example, a digital picture frame might transmit indications of modifications to pictures to a computer server for long-term storage. An attacker could pretend to be the digital picture frame 100 and transmit his own modifications to pictures to the computer server.

In addition, various information relating to a digital picture frame may be encrypted, including digital pictures, meta-data relating to digital pictures (e.g., modifications to pictures, annotations of pictures), and/or encryption keys (e.g., public-key cryptography may be used to exchange symmetric encryption keys for use during a communication session).

Examples of different types of pictures that may be encrypted include copyrighted, private, and pay-per-view pictures. For example, a digital picture frame may display photographs taken by a professional photographer. Without encryption, an attacker might copy these photos and distribute them (either for free or for profit), thereby infringing the professional photographer's copyright and possibly impeding the photographer's ability to earn income based on his photos.

In another example, a husband and wife may have a set of digital photographs from their honeymoon that they display on a digital picture frame. Without encryption, an attacker might intercept communications from the digital picture frame to another device (e.g., a controller) and post these pictures on the Internet.

In yet another example, a user may pay a fee based on one or more pictures he views using a digital picture frame. For example, a user may pay $0.01 per picture displayed on a digital picture frame. Without encryption, an attacker (e.g., a user) might be able to view pictures without paying a fee.

Note that encryption may provide a variety of benefits, including secrecy and authentication. Aspects of authentication include: data legitimacy, data paternity, data integrity, digital picture frame integrity, transmission integrity, non-repudiation.

A digital picture frame may store a secret key that may be used to encrypt information. For example, a digital picture frame may store a 128-bit private key for use in public-key encryption. This secret key may be stored in a memory of a digital picture frame, possibly inside a secure perimeter. Note that a secret key is not depicted in FIG. 1. A digital picture frame 100 may include a secure perimeter 106 that may prevent an attacker from tampering with a processor 102, a secret key, or other aspects of the digital picture frame 100.

A digital picture frame may include a cryptographic processor that may perform functions relating to encryption. This cryptographic processor may be implemented as part of the processor 102 or as a distinct device. Various encryption protocols may be used to encrypt information relating to a digital picture frame. Examples include: public-key encryption, symmetric key encryption, one-time pad, secret algorithm.

As mentioned above, information stored in a memory of a digital picture frame may be encrypted. Note that various aspects of cryptography mentioned above are known to those skilled in art and are not described in detail here. For reference, one of ordinary skill in the art may refer to Applied Cryptography, Protocols, Algorithms, And Source Code In C, (2d Ed, John Wiley & Sons, Inc., 1996) by Bruce Schneier which is hereby incorporated herein for all purposes.

In some embodiments, a user may use a digital picture frame 100 equipped with a camera, as a mirror. In such an embodiment, users can zoom in to see details of their faces or they can freeze a profile image so that they can view it without having to strain their neck as with conventional mirrors.

In some embodiments where an animated portion is added to an image (e.g. moving eyeballs on an otherwise stationary head), the animation may be programmed to be responsive to a viewer in the room with the digital picture frame 100. For example, the moving eyeballs can track the movement of the viewer as he moves through the room.

F. Conclusion

It is clear from the foregoing discussion that the disclosed systems and methods relating to digital picture frames and picture editing represent an improvement in the art of electronic displays and editing systems. While the method and apparatus of the present invention has been described in terms of its presently preferred and alternate embodiments, those skilled in the art will recognize that the present invention may be practiced with modification and alteration within the spirit and scope of the appended claims. The specifications and drawings are, accordingly, to be regarded in an illustrative rather than a restrictive sense.

Further, even though only certain embodiments have been described in detail, those having ordinary skill in the art will certainly appreciate and understand that many modifications, changes, and enhancements are possible without departing from the teachings thereof. All such modifications are intended to be encompassed within the following claims.

What is claimed is:

1. An apparatus comprising:
an enclosure having a window;
a display screen contained within the enclosure and visible through the window;
a processor coupled to the display screen and contained within the enclosure;
a mechanical edit control coupled to the processor and having a fixed portion and a moveable portion, wherein the fixed portion is mounted to the enclosure; and
a memory coupled to the processor and contained within the enclosure,
wherein the memory is operable to store information representative of an image,
wherein the display screen is operable to display a digital image representative of the information,
wherein the mechanical edit control is operable to send a signal to the processor,
wherein the processor is operable to alter the information in the memory based upon the signal, and
wherein the processor is operable to store the altered information.

2. The apparatus of claim 1 wherein the processor is operable to store a representation of the alteration of the information in association with the information.

3. The apparatus of claim 1 wherein the processor is operable to store a representation of the signal in association with the information.

4. The apparatus of claim 1 wherein the mechanical edit control includes a slider.

5. The apparatus of claim 4 wherein the signal indicates an area of the digital image to crop.

6. The apparatus of claim 4 wherein the signal indicates an area of the digital image to center.

7. The apparatus of claim 1 wherein the mechanical edit control includes a knob.

8. The apparatus of claim 7 wherein the signal indicates an area of the digital image to crop.

9. The apparatus of claim 7 wherein the signal indicates an area of the digital image to center.

10. A digital picture frame comprising:
a frame;
an enclosure attached to a rear side of the frame;
a processor mounted within the enclosure;
a memory coupled to the processor, mounted within the enclosure, and operable to store data representative of a digital image;
a display screen coupled to the processor, framed by the frame, viewable through a front side of the frame, mounted within the enclosure, and operable to display a representation of the digital image based on the data; and
a sensor coupled to the processor and mounted within the enclosure,
wherein the sensor is operable to send a signal to the processor,
wherein the processor is operable to modify the data in response to the signal, and
where the display screen is operable to modify the representation of the digital image based on the modified data.

11. The digital picture frame of claim 10, wherein information representative of the modification made to the data is stored in the memory in association with the data

12. The digital picture frame of claim 11, wherein an identity of a user is stored in association with the information representative of the modification made to the data.

13. The digital picture frame of claim 10 wherein the sensor includes an orientation sensor.

14. The digital picture frame of claim 10 wherein the sensor includes a voice recognition module.

15. The digital picture frame of claim 10 wherein the sensor includes a motion sensor.

16. The digital picture frame of claim 10 wherein the sensor includes a camera and an image recognition system.

17. The digital picture frame of claim 10 wherein the signal from the sensor includes information sufficient to enable the processor to identify a viewer proximate to the digital picture frame, and the processor is operable, in response to the signal, to display a video stream of images associated with the viewer.

18. A digital picture frame, comprising:
a display screen suitable for displaying a digital picture;
a processor coupled to the display screen;
at least one control coupled to the processor,
wherein the at least one control enables a user to edit the digital picture displayed on the digital picture frame,
wherein the processor is operable to store the edited digital picture,
wherein the at least one control is a mechanical control, and
wherein the at least one control performs a dedicated function.

19. A digital picture frame, comprising:
a display screen suitable for displaying a digital picture; and
a processor coupled to the display screen,
wherein the processor performs at least one function based on a voice command from a user.

20. A digital picture frame, comprising:
a display screen suitable for displaying a digital picture; and
a processor coupled to the display screen,
wherein the processor is operative to determine at least one modification to the digital picture, and
wherein the processor is operative, based on the at least one modification, to cause the display screen to display the digital picture.

21. A digital picture frame, comprising:
a display screen suitable for displaying a digital picture; and
a processor coupled to the display screen,
wherein the processor is operative to identify at least one user of the digital picture frame,
wherein the processor is operative to display the digital picture on the display screen based on the at least one user, and
wherein the processor is operative to enable the at least one user to edit the digital picture based on the identity of the at least one user.

22. An apparatus, comprising:
a digital picture frame including a memory that stores a secret key;
a computer server; and
a communication network that enables communication between the digital picture frame and the computer server,
wherein at least a portion of communication between the digital picture frame and the computer server is encrypted using the secret key.

23. A method comprising:
storing information representative of an image in a memory of a digital picture frame;
displaying a digital image representative of the information on a display screen;
receiving a signal representative of an edit of the digital image from a mechanical edit control attached to the digital picture frame;
altering the information in the memory based upon the signal;
storing the altered information; and
displaying a digital image representative of the altered information on the display screen.

24. The method of claim 23 further including storing a representation of the alteration of the information in association with the information.

25. The method of claim 23 further including storing a representation of the signal in association with the information.

26. The method of claim 23 wherein receiving a signal representative of an edit includes receiving a signal from a slider.

27. The method of claim 26 wherein receiving a signal includes receiving a signal that indicates an area of the digital image to crop.

28. The method of claim 26 wherein receiving a signal includes receiving a signal that indicates an area of the digital image to center.

29. The method of claim 23 wherein receiving a signal representative of an edit includes receiving a signal from a knob.

30. The method of claim 28 wherein receiving a signal includes receiving a signal that indicates an area of the digital image to crop.

31. The method of claim 28 wherein receiving a signal includes receiving a signal that indicates an area of the digital image to center.

32. A method of operating a digital picture frame comprising:
receiving a signal from a sensor mounted within an enclosure of a digital picture frame;
modifying data representative of a digital image stored within a memory mounted within the enclosure wherein the data is modified based upon the signal; and
displaying the modified data on a display screen mounted within the enclosure and visible via an opening in the enclosure.

33. The method of claim 32, further including storing information representative of the modification made to the data in the memory in association with the data.

34. The method of claim 33, further including storing an identity of a user in association with the information representative of the modification made to the data.

35. The method of claim 32 wherein receiving a signal from a sensor includes receiving a signal representative of orientation data from an orientation sensor.

36. The method of claim 32 wherein receiving a signal from a sensor includes receiving a signal representative of viewer identity data from a voice recognition module.

37. The method of claim 32 wherein receiving a signal from a sensor includes receiving a signal representative of edit control data from a voice recognition module.

38. The method of claim 32 wherein receiving a signal from a sensor includes receiving a signal representative of control data from a motion sensor.

39. The method of claim 32 wherein receiving a signal from a sensor includes receiving a signal representative of viewer identity data from a camera and an image recognition system.

40. The method of claim 32 wherein receiving a signal from a sensor includes receiving information sufficient to enable identification of a viewer proximate to the digital picture frame, and wherein the method further includes displaying a video stream of images associated with the viewer in response to the signal.
